(19) United States
(12) Patent Application Publication
(10) Pub. No.: US 2003/0022616 A1
(43) Pub. Date: Jan. 30, 2003

(54) Air vent

(75) Inventor: Udo Stiehl, Hochspeyer (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive Electronics & Components GmbH & Co. KG

(21) Appl. No.: 10/200,651

(22) Filed: Jul. 22, 2002

(30) Foreign Application Priority Data
Jul. 26, 2001 (DE) 101 36 376.1

(51) Int. Cl. B60H 1/24

(52) U.S. Cl. 454/162

(57) ABSTRACT

An air vent, in particular for venting an interior of a vehicle, comprises a frame and at least one check flap, an antenna being fitted to the frame.

### TECHNICAL FIELD

The invention relates to an air vent, in particular for venting the interior of a vehicle, including a frame and at least one check flap.

### BACKGROUND OF THE INVENTION

Vehicles nowadays are provided with various transmitting and receiving systems, for example for mobile radio telephones, emergency call systems or navigation systems. These transmitting and receiving systems require, as a rule, a separate antenna suitably located on the vehicle.

The object of the invention is to accommodate an antenna in a vehicle so that it has good transceiver performance whilst being simple to fit.

### BRIEF SUMMARY OF THE INVENTION

According to the invention, an air vent, in particular for venting an interior of a vehicle, comprises a frame and at least one check flap. An antenna is fitted to the frame. Thus, the antenna can be spaced away from the vehicle body, resulting in good transceiver performance of the antenna. The antenna can be fitted to the air vent before the latter is secured in the vehicle so that assembly is now simpler and more cost-effective.

Further advantageous embodiments read from the sub-claims.

### BRIEF DESCRIPTION OF THE DRAWINGS

FIG. 1 is a perspective view of an air vent according to the invention;

FIG. 2 is a perspective view of the frame of the air vent as shown in FIG. 1;

FIG. 3 is a magnified view of the portion III as shown in FIG. 2;

FIG. 4 is a magnified view of the portion IV as shown in FIG. 2;

FIG. 5 is a magnified view of the portion V as shown in FIG. 2;

FIG. 6 is a magnified view of the portion VI as shown in FIG. 2.

### DETAILED DESCRIPTION OF THE PREFERRED EMBODIMENT

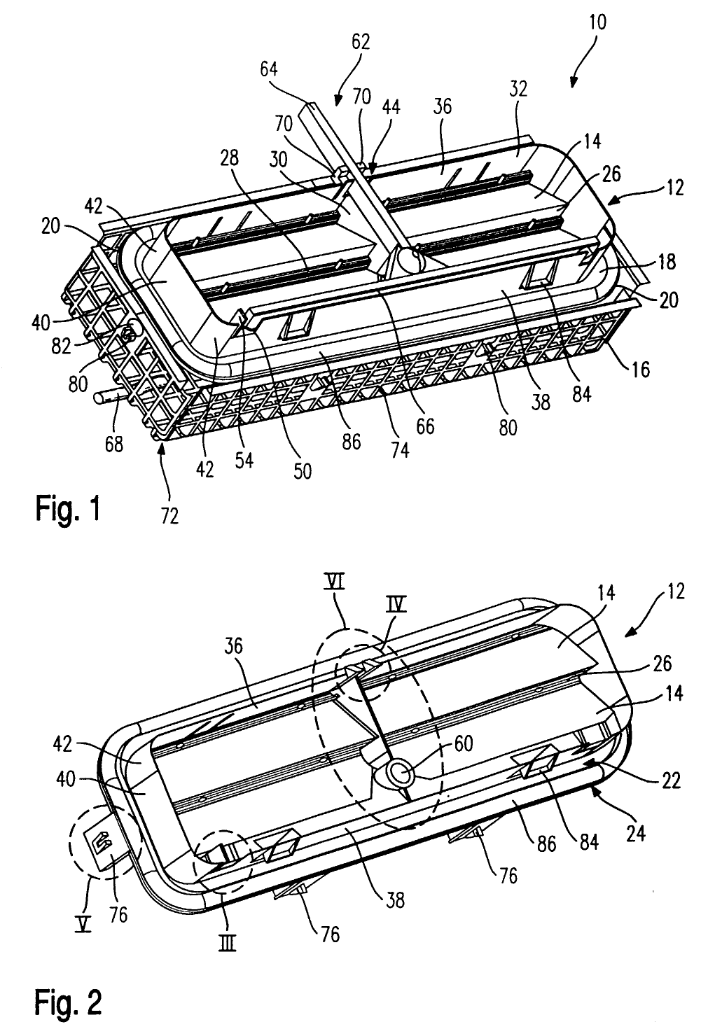

Referring now to FIG. 1 there is illustrated an air vent 10 consisting of a frame 12 including check flaps 14 and a reflector 16. The frame 12 is formed by a rectangular baseplate 18 having rounded comers 20, featuring an upper side 22 and an underside 24. Configured in the baseplate 18 is a through-flow opening 26 (FIG. 2) which can be closed off by the check flaps 14. Since the basic functioning of the air vent 10 is known from prior art, it is not further detailed here.

For stabilizing, the through-flow opening 26 is bridged by a longitudinal web 28 and a cross web 30 forming a right-angled cross over the through-flow opening 26. Extending perpendicular to the plane of the baseplate 18 at the upper side 22 of the baseplate 18 is a connecting wall 32 having an inner side facing the through-flow opening 26, surrounding the through-flow opening 26 at its rim and serving for guiding the air vent 10 in an aperture in the vehicle body when fitted in a vehicle, for example. The connecting wall 32 is made up of a first longitudinal wall section 36 adjoining a longitudinal side of the through-flow opening 26, a second longitudinal wall section 38 parallel to the first longitudinal wall section 36 and two short straight transverse wall sections 40 connecting the longitudinal wall sections 36 and 38 along the narrow sides of the through-flow opening 26 via curved wall sections 42.

In the middle of the first longitudinal wall section 36 there is provided a recess 44 (see FIG. 4) into which two latching tabs 46 spaced away from each other extend in parallel. The latching tabs 46 protrude beyond the rim of the first longitudinal wall section 36 remote from the baseplate 18 and are provided at each end with a wedge-shaped hook 48.

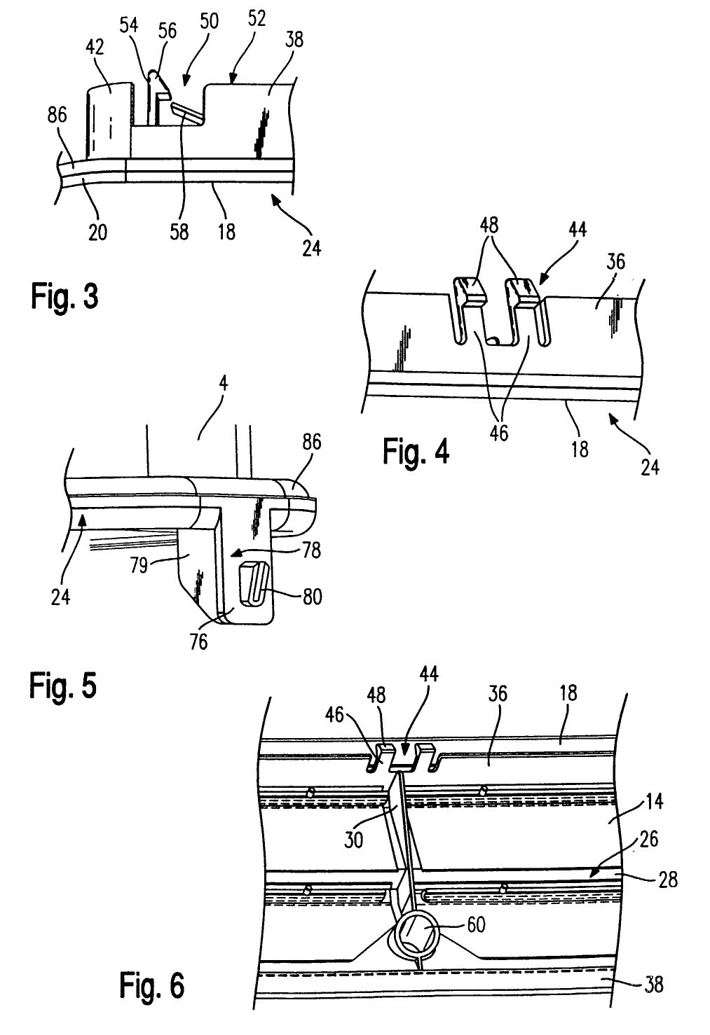

Referring now to FIG. 3, there is illustrated a recess 50 which is provided at each end of the second longitudinal wall section 38 of the connecting wall 32 so as to adjoin the curved wall sections 42. Provided at the inner side 52 of the second longitudinal wall section 38 in the portion between the recess 50 and the rim of the through-flow opening 26 are snap-action tabs 54, which each protrude into the portion defined by recess 50 on the inner side 52 of the longitudinal wall section 38. Each snap-action tab 54 is provided in turn at its free end with a wedge-shaped hook 56 (FIG. 3). Furthermore, extending from the inner side 52 of the second longitudinal wall section 38 in the direction toward each snap-action tab 54 is a flexible spring web 58, each of which protrudes from the rim of the recess 50 by its free end in the direction toward the wedge-shaped hook 56.

At the level with the recess 44, the inner surface areas of the first longitudinal wall section 36 and of the second longitudinal wall section 38 are connected by the cross web 30, which nearby the second longitudinal wall section 38 is flared into a mounting opening 60 (FIG. 6). This mounting opening 60 has the shape of a circular cylindrical tube and leads to the underside 24 of the baseplate 18.

A T-shaped antenna 62 comprising a middle bar 64 and a crossbar 66 is fitted to the frame 12. Provided at the joint between the middle bar 64 and the crossbar 66 of the antenna 62 is a protuberance through which a connecting cable 68 emerges from the antenna 62. When fitting the antenna 62, the connecting cable 68 is guided through the mounting opening 60, and the protuberance, configured for example cylindrical or conical, is inserted into the mounting opening 60 to thus center the antenna 62 on the frame 12. The antenna 62 is fixed to the frame 12 furthermore by means of three fastener points, namely in the region of the recess 50 between the snap-action tabs 54 and the spring webs 58 as well as by protrusions 70 configured on the middle bar 64, these protrusions 70 cooperating with the latching tabs 46 by being clasped by the wedge-shaped hooks 48 to thus form a latching connection. In this way a simple but reliable and rugged fitting of the antenna 62 on the frame 12 is produced. The frame 12 of the air vent 10 is preferably made of plastics so as not to detriment the electric field of the antenna 62. The T-shape of the antenna is particularly of advantage for it being fitted to the frame 12 since it does not reduce the through-flow opening 26.

In the illustrated embodiment the reflector 16 is configured as a cuboidal cage produced as a stamped sheet-metal grille, comprising a base 72 and side surface areas 74. The aperture of the cage is provided to accommodate the frame 12. Referring now to FIG. 5 there is illustrated how retaining tabs 76, extending perpendicularly from the underside 24 of the baseplate 18, are provided for securing the reflector 16. The front side 78 of the retaining tabs 76 facing away from the through-flow opening 26 is flush with the outer edge of the baseplate 18, whilst the rear side rests at the underside 24 of the baseplate 18 by means of a web 79. Configured at the front side 78 of each retaining tab 76 is a wedge-shaped snap-action hook 80.

To fit the reflector 16 it is mounted by its side walls 74 over the retaining tabs 76, the side walls 74 being flexed outwardly by the snap-action hooks 80 until the snap-action hooks 80 snap into the recesses 82 in the side walls 74, so that the reflector 16 is reliable secured to the frame 12. The connecting cable 68 can then be simply guided to the outside through the gaps in the metal grille.

The air vent 10 in accordance with the invention may be fitted, for example, in a panel aperture in the vehicle trunk, for compensating any increase in pressure in the vehicle interior by means of the check flaps 14. The air vent 10 permits very simple installation in the vehicle by it being inserted with the connecting wall 32 into the panel aperture in the vehicle, the fastener tabs 84 configured in the connecting wall 32 securely clasping the air vent 10 in the panel aperture. A gasket 86 running around the upper side of the baseplate seals off the air vent 10. The antenna 62 is thus accommodated in the vehicle safe from physical damage and is protected by the reflector 16 from sources of interference in the vehicle interior.

1. An air vent, in particular for venting an interior of a vehicle, said air vent including a frame and at least one check flap, an antenna being fitted to said frame.

2. The air vent as set forth in claim 1, wherein a latching connection is provided by means of which said antenna is fitted to said frame.

3. The air vent as set forth in claim 2, wherein said latching connection consists of two latching tabs on said frame and two protrusions on said antenna, said protrusions cooperating with said latching tabs.

4. The air vent as set forth in claim 1, wherein provided on said frame is a mounting aperture into which a protuberance configured on said antenna can be inserted.

5. The air vent as set forth in claim 2, wherein provided on said frame are two snap-action tabs and wherein said antenna has two ends, said tabs being capable of engaging said ends of said antenna.

6. The air vent as set forth in claim 5, wherein said antenna is configured T-shaped and said latching tabs engage a middle bar of said antenna whilst said snap-action tabs engage ends of said crossbar of said antenna.

7. The air vent as set forth in claim 1, wherein a reflector is provided which is fitted outside of said frame.

8. The air vent as set forth in claim 7, wherein said frame consists of a metal grille.

9. The air vent as set forth in claim 7, wherein said frame is provided with several snap-action hooks for engaging said reflector.
